(19) United States
(12) Patent Application Publication
(10) Pub. No.: US 2007/0102570 A1
(43) Pub. Date: May 10, 2007

(54) Aircraft

(76) Inventor: Charles Raymond Luffman, Staakow (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/547,205

(22) PCT Filed: Feb. 24, 2004
(86) PCT No.: PCT/GB04/00742

§ 371 Date: Aug. 14, 2006

(30) Foreign Application Priority Data
Feb. 24, 2003 (GB) 0304124.1
Nov. 4, 2003 (GB) 0325699.7

(51) Int. Cl. B64B 1/02

(52) U.S. Cl. 244/30

(57) ABSTRACT

An aircraft comprising an envelope (6) that is inflatable with a lifting gas that is lighter than air that, at least when inflated has curved upper and lower surfaces. The aircraft has a payload carrying means (5), and an aerodynamic lifting means (8) for creating a vertical annular flow of air that induces a flow of air over the respective upper or lower surface (12, 14) of the envelope (6.). One form of aerodynamic generator (8) comprises a plurality of aerofoil blades (20) mounted for rotation around a periphery of the envelope (6).

This invention relates to aircraft suitable for transporting outsized heavy payloads and in particular, although not exclusively, to aircraft that can pick up a load (difficult to transport by road) at a client's site, transit directly without external assistance to another site and then set the load down where wanted without additional infrastructure. This invention also relates to lighter-than-air vehicles and in particular to such a vehicle for providing a stratospheric platform suitable for telecommunications and other electronic equipment operations.

To achieve an aircraft for transporting outsized payloads, the basic requirements are:—
able to fly autonomously by autopilot signals and/or be manually controlled by a pilot on board;
takeoff from, or settle to land, at its ground base station plus free flight within its operational ceiling without additional ground infrastructure other than that already existing for conventional aircraft;
depending on basic size, able to carry a variety of heavy and or large loads, typically: 100, 500 and (as a goal) 1000 tonne or more plus sized typically within a 50 m spherical envelope, in a manner suitable for the purpose (depending on vehicle size developed);
able to pick up or set down prepared or packaged payloads directly with vertical lift (as a crane);
operation typically up to 2500 m above sea level (higher for variants);
continuous free flight operation for periods typically not less than 12 hours-48 hours as a goal (longer for variants);
ability to remain typically within 5 m radius of a geostationary position at the payload pickup and set down sites (horizontally and vertically);
range typically up to 1000 km, depending on fuel provisions—4000 km as a goal;
maximum flight speed typically up to 60 knots (111 km/h) as a goal;
cruise flight speed typically 45 knots (83 km/h);
able to settle at ground-level from free flight or take off from a ground base station (or other suitable sites) essentially unaided;
able to be moored and held indefinitely at the ground base station;
able to withstand wind conditions whilst moored up to 60 kts (111 km/h) without damage;
able to withstand storm conditions whilst moored under gusting winds of 80 kts (148 km/h) without breakaway;
able to launch or be captured in winds at 50 m above the ground up to 25 kts (46 km/h)-30 kts (56 km/h) as a goal;
able to pick up or set down packaged payloads in winds at 100 m above the ground up to 20 kts (37 km/h)-25 kts (46 km/h) as a goal;
able to be maintained at the ground station using standard low reach equipment;
able to be recovered safely to ground level following total power system failure;
able to be operated from ground station set-ups in locations typically accepted for normal aircraft operation;
able to be packaged and delivered by road;
able to be assembled, inflated, set up for operation and maintained at a ground base station mooring site without a hangar;
able to achieve high utilisation compared with commercial aircraft.

The basic requirements for a stratospheric platform vehicle are similar to those highlighted above, but some differences apply, namely:
able to house and protect the payload from adverse environmental effects;
able to provide sufficient power for operation of the payload systems;
operation at 20 Km±1 km above sea level;
continuous free flight operation for periods not less than 30 days-90 days as a goal;
ability to remain within 1 km radius of a geostationary position at the operational height;
able to descend under free flight to the ground station without damage;
able to be captured from free flight at the ground station;
able to be operated from ground station set-ups in locations typically accepted for normal aircraft operation;

Transport of very large heavy, often indivisible, payloads over land is a significant problem for industrialists who, so far, do not have an easy solution. Even loads that are to be transported by sea must be delivered to the pickup dockyard over land and then later taken from their destination dockyard over land to the delivery address.

Unless rivers or canals are available (unlikely), current over land methods have little option but to employ roads and rails together with the vehicles to move along them. Numerous effectively irremovable obstacles such as bridges, tunnels, pylons and stations or other buildings make such transport of large loads almost impossible. Quite often the terrain or the route through particular areas may also be very difficult to negotiate and there may not be an existing or suitable road or rail system for the transport operation to use.

There is a need to be able to pick up at A, travel directly through the air to B and then set down by a method that has no obstacles and is cost effective—perhaps similar to transport by ship.
There are three categories of aircraft relevant to the present invention:
Heavier-than-air (HTA) vehicles,
Lighter-than-air (LTA) vehicles,
Hybrid vehicles.

HTA vehicles primarily utilise aerodynamic methods to generate lift, which necessitates movement of an aerofoil or lifting body shape through the air, whilst LTA vehicles mainly utilise aerostatic lift methods. Hybrids may use both, and be of non-conventional form. Thrust from propulsive units also may be used for lifting purposes and this generally has been applied before to each category, typically with vector mechanisms to orientate the thrust direction.

The reason that perhaps a successful vehicle able to meet the above basic requirements has not already emerged is that it is extremely difficult to do, particularly in the light of established airworthiness standards and practices, which need compliance.

Clearly the fuel, structure, systems, crew and other disposable loads must be drastically minimised to maximise the potential for payload carrying ability. The aircraft itself also will be very big compared with existing or previous aircraft already produced.

Balloons often adopt a natural non-pressurised form, enabling very light fabric to be used for containment of the lifting gas. Such forms are not well suited to mount thrust units and other system features, since they are delicate and the membrane is not stable enough (due to low pressure). Non-rigid airships use super pressure to stabilise the envelope membrane, enabling other features to be mounted.

Lighter-than-air (LTA) vehicles, typically balloons, aerostats and airships, can be used as aerial platforms to carry various payload arrangements. Their slow speed plus ability to float without need for aerodynamic lift generation (to carry their weight) or disturbance of the surrounding atmosphere, quietly maintain station over a ground position with little effort for long periods of time and provide a stable, vibration free environment with all round unobstructed views of the surface below are advantages ideal for aerial surveillance or other area coverage roles. Recently over the last 10 years or so there has been purposeful interest to use LTA aircraft in the stratosphere as platforms for telecommunications and other electronic systems. This has not come to fruition yet due to the difficulties involved in making a suitable vehicle.

The idea evokes interest since at such heights LTA vehicles would be able to perform similar roles to satellites, although with very much reduced cost and better performance. Also, they could be recovered and re-deployed whenever conditions were suitable (an aspect too difficult and expensive for satellites to do generally) and may be used as relay points for satellites, other aircraft or ground systems—to extend and enhance existing communication systems.

Currently, there are no commercial LTA vehicles able to fulfil the role outlined in the above basic requirements. Interest has led to proposals for extended airship use, since (to maintain a geostationary position—rather than drifting in the wind) directional control and flight against air currents, plus vertical drafts, are necessary. Tethered aerostats also have been considered, but the weight and deployment/recovery problems with such long tethers make these unsuitable and they are not able to maintain geostationary positions with sufficient accuracy. The tether also is a hazard to lower flying aircraft and is not easy to detect.

A basic problem that the vehicle must solve in order to attain and be capable of operation at the required altitude and be recoverable, is expansion of the lifting gas without rupture of the containment cell, or unwanted gas release. Expansion of the lifting gas will be considerable (about 15 times the volume of the initial ground level gas fill charge at the operating height).

For an airship to operate and be controllable it must maintain its basic shape and rigidity. Non-rigid airships do this by pressure stabilisation of the gas containment envelope (also the airship's hull). To avoid loss of gas, non-rigid airships use internal cells (ballonets) filled with air to keep the air separate and make up the fill deficit necessary when the airship is at low altitude. After filling, by pumping additional air into the ballonets the envelope is pressurised and by releasing air from the ballonets via valves an overpressure situation is avoided without releasing the lifting gas. Also, the super pressure generated is regulated via a control system to maintain constant levels. A ballonet sized with at least 93% of the envelope's capacity would be necessary for a non-rigid airship to maintain adequate form throughout the ascent and descent. Discharge valves and blowers also must be provided of sufficient capacity to accommodate the respective rate of expansion or contraction of the gas during the climb and descent, depending on the vertical velocity and environmental effects. The power requirements and resultant weight of these systems will be of significant consequence.

A rigid airship, which allows its gas cells to expand freely and contract within the hull framework, would face similar problems—although blowers would be unnecessary. The main problem here is the size of the structure (and consequent weight) that results. An airship with about 350,000 to 400,000 m³ capacity would be necessary to meet the above requirements.

Very large manned free balloon systems have been successfully used and are able to endure variable conditions over extended periods. Compared with airships, which are subject to super pressure levels to stabilise and stiffen their envelopes (resulting in heavy fabric weights), such balloons are able to utilise naturally shaped envelopes that require no additional pressurisation other than that resulting from the gas pressure head. These envelopes may therefore be of very lightweight fabric, enabling smaller overall size, reduced cost and improved handling ability.

Simple balloons, which just float in the air stream (moving with it), however, are not subject to such adverse conditions as would be experienced when there is relative airspeed. Also, their lack of stiffness makes it difficult to mount or operate thrust systems and their envelope surface does not adapt very well to mount solar power panels. Additionally, the gas expansion causes a significant envelope profile change as the balloon transits between ground level and the stratosphere; being at low altitude a very long inverted tear drop (bulbous head with long vertical gathered and tapering tail) whilst at high altitudes reduces vertical length and fills out to a spherical shape. These aspects make them very difficult to adapt.

Lastly, solar power has been discussed above without explanation for its use. Any LTA vehicle able to attain the height required will take quite a long time to do this, through difficult circumstances and with similar aspects when returning to the ground, which should not be repeated unnecessarily. Users of the platform also will want their systems to remain on station for as long as possible (30 days or more). Large quantities of consumable fuels, if used alone, would therefore need to be carried adding weight that must be buoyed. This is an escalating effect on the resulting vehicle size that makes it unviable. Also, as the fuel is used, the gross weight reduces. The buoyancy or gas lift, however, remains more or less constant (depending on external environmental conditions) so would cause the vehicle to rise if thrust is not employed to counteract the accessional imbalance—otherwise the lifting gas must be vented to reduce buoyancy.

This is a common problem for airships, which normally counteract the imbalance with aerodynamic lift on the hull (as a lifting body). To generate aerodynamic lift airspeed and a means for pitch control plus a suitable lifting body shape are necessary, adding complexity and thus weight plus cost. Water recovery from the burnt fuel has been another way to maintain constant weight of the system. Regardless, these are features that this proposal seeks to obviate.

Solar energy, which can be harnessed via collector panels, provides a way to generate power at constant weight and should be available over long periods, so is a natural choice as the prime method for power generation. In the stratosphere there should be little to interfere with this process although in the lower atmosphere with cloud cover and at night, a secondary means of power generation may be necessary. Provided that big enough solar panels can be installed with sufficient efficiency and batteries installed adequate to provide power through the night the system should be able to cope. Nonetheless, as backup and to serve needs for the payload systems other more conventional methods also may be employed. These, of course, would need to be able to operate in the stratosphere.

An object of the present invention is to make use of pressure stabilised membrane technology for stiffening purposes of such aircraft, where necessary.

A further object of the present invention is to utilise the simplicity, weight, and cost effectiveness of balloon technology with a novel aerodynamic lift system to provide a commercially viable transport aircraft that can operate autonomously.

Also, a further object is to provide an aircraft comprising an envelope inflated with a gas that is lighter than air (thereby to generate aerostatic lift), with an aerodynamic lifting device that does not require movement (translation or rotation) of the aircraft's main body to generate the aerodynamic lift.

According to one aspect of the present invention there is provided an aircraft comprising an envelope that is inflatable with a lifting gas that is lighter than air and has, at least when inflated, curved upper and lower surfaces, a payload carrying means, and an aerodynamic lifting means operable to generate lift on the envelope by causing a vertical annular flow of air that further induces a flow of air over the respective incident upper or lower curved surface thereby to generate lift.

The vertical annular flow may be upwards or downwards.

Preferably the aerodynamic lifting means comprises a plurality of aerofoil blades mounted for rotation around a periphery of the envelope.

Preferably the aerofoil blades are variable pitch blades, and blade pitch control means are provided for varying the pitch of the blades collectively to effect directional control of the resulting annular air flow.

Preferably thrust control units are attached to the envelope to provide directional thrust to the aircraft.

Ideally the envelope is of circular shape when viewed in plan, and the blades rotate about a vertical centre-line axis of the envelope. Other plan shapes are possible such as, for example, an oval, ogival, or elliptical shape, but in these cases means have to be found to drive the blades around the perimeter of the envelope. One way of doing this would be to mount the one or more blades on interconnected carriages that are around the perimeter by a linear electric motor.

Preferably the envelope is of lenticular shape when viewed in elevation.

A second aspect of the invention provides a lighter-than-air vehicle comprising; a structural ring member having attached around a perimeter thereof a first flexible gas impermeable membrane, a second flexible gas impermeable membrane, and a diaphragm that, at least temporarily, is located between the first and second membranes to define an upper chamber that is inflatable with a lifting gas bounded, at least in part, by the first membrane and the diaphragm, and a lower chamber bounded at least in part by the second membrane and the diaphragm, said diaphragm being either removable after the upper chamber is inflated with a lifting gas but prior to the first ascent of the vehicle, or having venting means for allowing the lifting gas in the upper chamber to expand and pass through the diaphragm during ascent of the vehicle, thereby to allow the lifting gas to expand into the space bounded at least in part by the second membrane; and a payload capsule suspended from the structural ring member.

In some embodiments, the structural ring member is a hollow inflatable structure.

Alternatively, the structural ring member is a hollow rigid structure.

In some embodiments, the structural ring member is a flexible structure.

According to an optional feature of the second aspect of the invention, the structural ring member has internal bulkheads.

Optionally, the first membrane forms a dome shape when inflated.

According to another optional feature of the second aspect of the invention, the second membrane is of a distended conical shape and is attached at an upper end around a circumference of the structural ring member. Preferably, the second membrane is provided with a lower ring member attached to a lower end of the second membrane.

In some embodiments, a payload capsule suspension system is provided comprising tie members that extend in a radial direction from the structural ring member to an upper hub assembly, and a downwardly directed tie member that extends vertically from the upper hub assembly, and the payload capsule is connected to a lower support hub attached to the lower end of the downwardly directed tie member. The lower ring member may be moveable vertically relative to the downwardly directed tie member.

Optionally, the payload capsule is attached to the lower ring member by way of retractable tension lines that urge the lower ring member towards the payload capsule.

According to a further optional feature of the second aspect of the invention, a gaiter is provided between the lower ring member and the lower support limb to allow vertical movement of the lower ring relative to the lower support limb.

In some embodiments, the diaphragm is connected to the structural ring member by a joint that enables the diaphragm to be removed prior to the first ascent of the vehicle. Preferably, the diaphragm is provided with controlled venting means for allowing lifting gas from the upper chamber to expand and flow through the diaphragm into the lower chamber in a controlled manner.

Propulsion means may be connected to the structural ring member.

It is envisaged that the solar power panels are located on the upper membrane.

A mast may be provided that projects upwardly from the upper membrane of the upper chamber.

A third aspect of the invention provides a method of launching a vehicle constructed in accordance with any one of the preceding claims, the method comprising securing the vehicle to the ground by mooring lines inflating the upper chamber with a lifting gas that is lighter than air, evacuating the lower chamber to provide a volume for receiving expanded lifting gas from the upper chamber, and releasing the mooring lines.

According to an optional feature of the third aspect of the invention, there further includes the steps prior to inflating the upper chamber with the lifting gas of inflating the upper and lower chambers with pressurised air so as to raise the structural ring member and the upper chamber from the ground, and subsequently evacuating the upper chamber of air.

Exemplary embodiments of the present invention will now be described, by way of example only, with reference to the accompanying drawings, in which:—

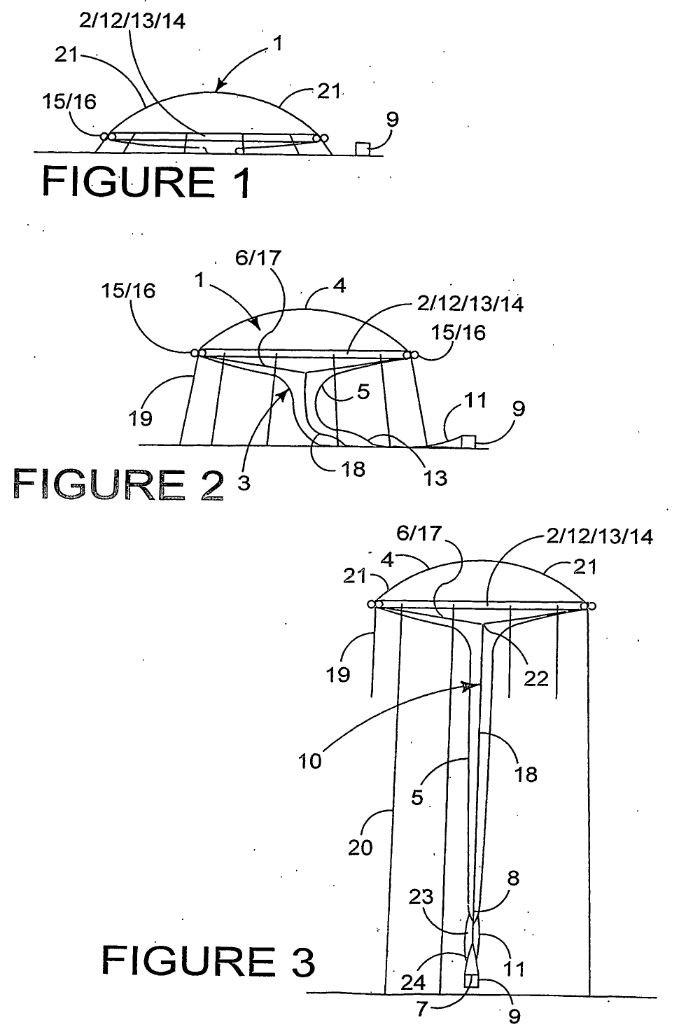

FIG. 1 is a side view of a lighter-than-air vehicle constructed in accordance with a first embodiment of the present invention showing the vehicle in a moored position;

FIG. 2 is a side view of the vehicle of FIG. 1 in a second moored position;

FIG. 3 is a side view of the vehicle of FIG. 1 in a pre-launch or post recovery position;

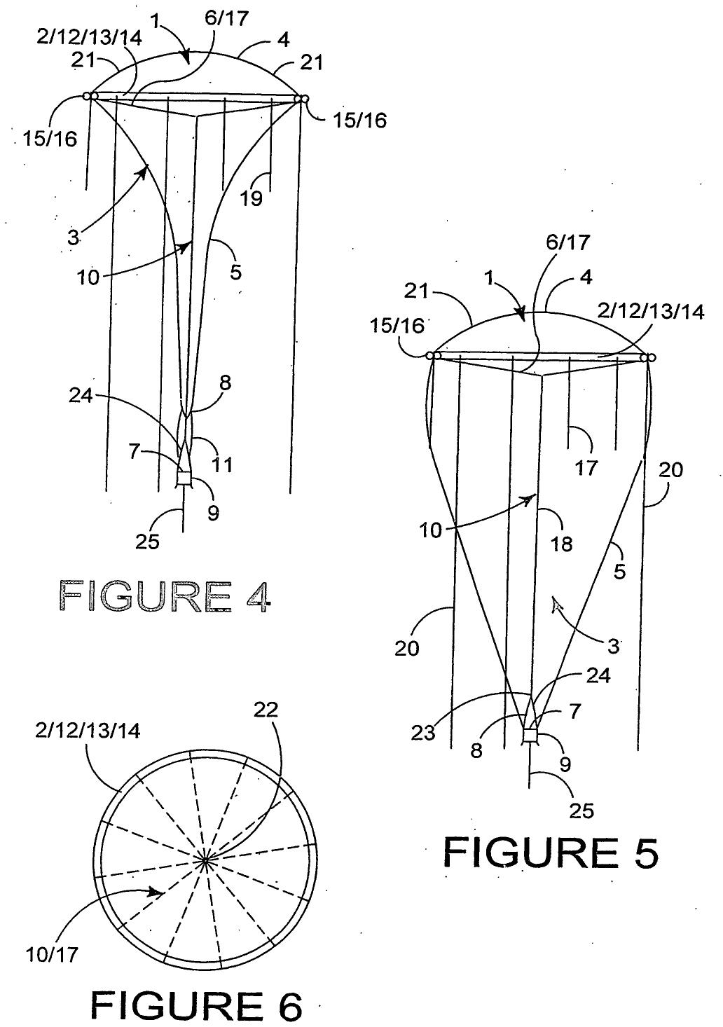

FIG. 4 is a side view of the vehicle of FIG. 1 showing the vehicle in a free flight position at low altitude;

FIG. 5 is a side view of the vehicle of FIG. 1 showing the vehicle in a free flight position in the stratosphere;

FIG. 6 shows a plan view of part of the support structure of the vehicle of FIG. 1;

FIG. 7 shows the side view of an aircraft constructed in accordance with a second embodiment of the present invention in a high moored configuration;

FIG. 8 shows the side view of the aircraft of FIG. 7 in an intermediate moored configuration;

FIG. 9 shows the side view of the aircraft of FIG. 7 in a low (storm) moored configuration;

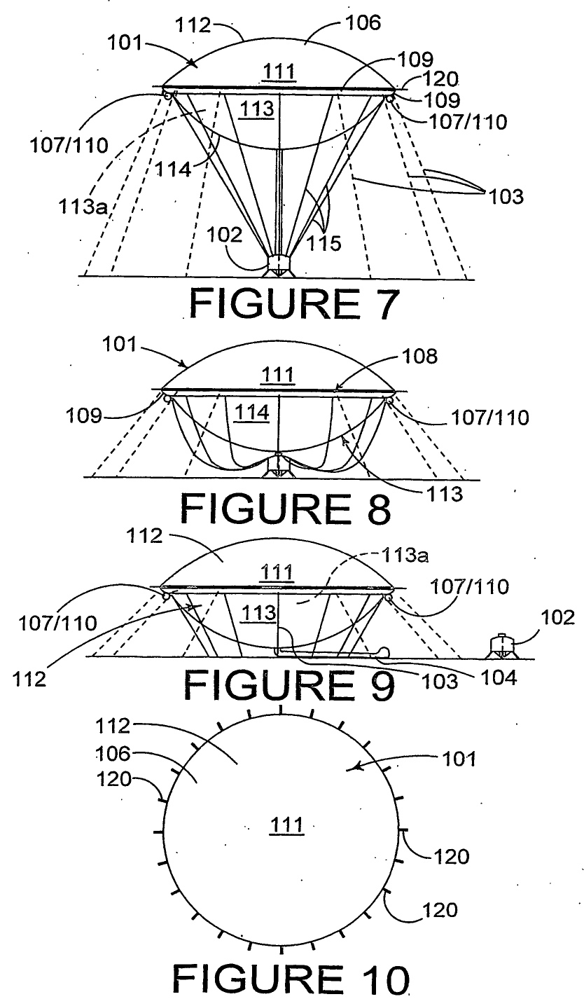

FIG. 10 shows a plan view of the aircraft of FIG. 7 (from above);

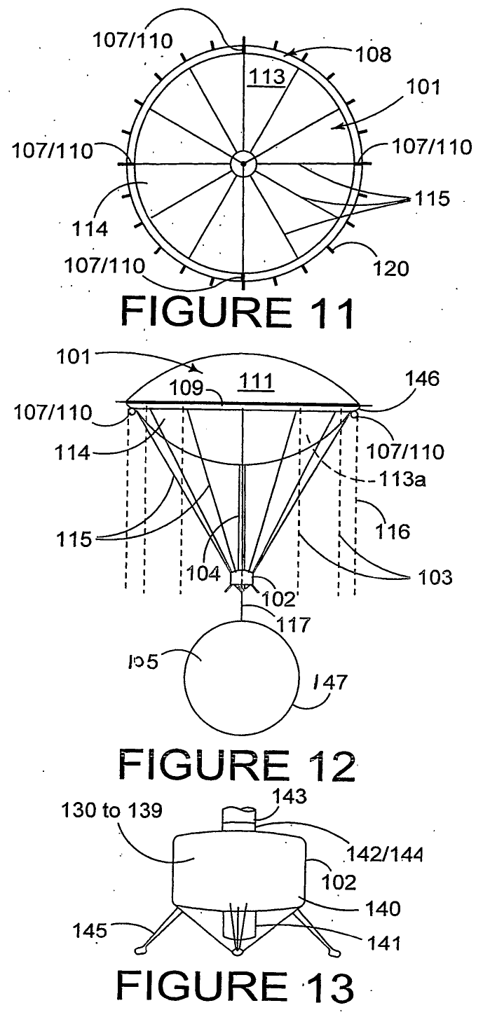

FIG. 11 shows an inverted plan view of the aircraft of FIG. 7 (from below);

FIG. 12 shows a side view of the aircraft of FIG. 7 transporting a pay-load in free flight;

FIG. 13 shows in more detail the main under slung working module of the aircraft of FIG. 7;

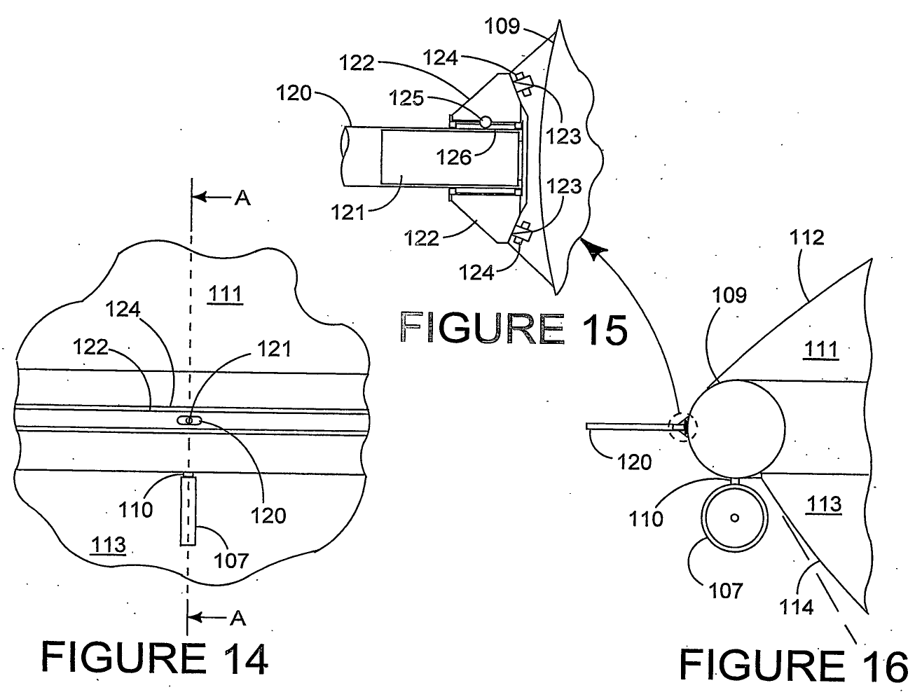

FIG. 14 shows schematically a side view of the aircraft of FIGS. 7 to 13 showing one form of aerodynamic lift generator constructed in accordance with the present invention;

FIG. 15 shows in greater detail a view taken along line A-A of FIG. 14; and

FIG. 16 shows in larger scale the detail of the aerodynamic lift generator mechanisms shown in FIGS. 14 and 15.

Referring to the first embodiment illustrated in FIGS. 1 to 6, the lighter-than-air (LTA) vehicle comprises an upper envelope assembly 1, a stiffening ring assembly 2, and a lower envelope assembly 3 (FIG. 2). In operation, the upper envelope assembly 1 is inflated with a lifting gas such as helium or hydrogen and the stiffening ring assembly 2 constitutes the main structural component of the LTA vehicle. The lower envelope assembly 3 provides a reserve compartment to contain the lifting gas from the upper envelope chamber 1 as it expands, mainly through ascent, and until contracting through descent or other climatic changes.

The basic components of the LTA vehicle are best seen in FIGS. 3 to 5.

The upper envelope 1 is made of a membrane 4 of gas impermeable flexible fabric that is attached in a gas-tight manner around its perimeter to the ring 2 at a location tangential to the upper outer quadrant of the cross-sectional diameter of the ring 2. A second membrane 5 of gas impermeable material is attached to the ring 2 below the upper membrane 4. The second membrane 5 provides the main outer boundary of the second envelope 3. A diaphragm 6 (FIG. 2) is attached to the ring 2 at a location between the first and second membranes 4 and 5. As explained below, the diaphragm 6 may either be permanently attached to the ring 2 and provided with controllable openings to allow lifting gas to flow into the second lower envelope 3 and return, or it may be detachable from the ring 2 after the LTA vehicle's assembly/inflation, prior to first ascent of the vehicle as will be explained in more detail later.

In this embodiment, the membrane 5 is of a distended conical shape and is attached at its uppermost perimeter to the ring 2 in a gas tight manner. As illustrated In FIG. 3, the lowermost end of the second envelope 3 there is provided a lower ring 7 and a closing gaiter 8 connected between the lower ring 7 and the payload suspension system 10 so as to allow vertical movement of the lower edge of the membrane 5 relative to the suspension system 10 as explained later. A payload capsule 9 is carried by a suspension system assembly 10 from the stiffening ring 2, as will be explained later. The lower ring 7 is interconnected with the capsule 9 by a tensioning line system 11 shown in FIG. 3, also as will be explained later.

The upper ring 2 is the main structural member of the LTA vehicle and comprises a toroid of normally 50 to 100 metres diameter having a circular cross sectional shape of typically 1 to 5 metres diameter. The upper ring 2 must be constructed so that it holds its shape, and provides a chassis on which the other components of the vehicle are mounted.

The upper ring 2 may be filled with the lifting gas (to help carry its weight), but it is not intended to be the main container of the lifting gas and it does not provide the main hull body. It is there primarily as a stiffening member. It also may act as a reserve chamber to store helium. It also is pressurised to a much higher level than that of LTA vehicle envelopes in general and of envelopes 1 and 3 here.

The tube of the upper ring 2 may be constructed as a conventional thin walled rigid shell, or made of pressure stabilised fabric membrane material. If the later, then a pressurisation system 12 will be needed to inflate the ring 2. A non-rigid pressurised ring 2 is preferred, since this will be more consistent with main envelope attachments, will be more flexible (to avoid damage under overload situations) and will enable delivery of the complete envelope fully assembled.

The lifting gas may be utilised as the medium for pressurisation of the upper ring 2, taken from the upper envelope chamber 1. As a relatively small cross-sectional diameter tube, the ring 2 would be subject to high internal pressure compared with normal airship envelopes, since the resulting membrane stress is proportional to pressure and radius. Thus, whilst a typical airship envelope would be subject to about 500 Pa super pressure, the tubular ring 2 if of 2 metres cross-sectional diameter would need about 35,000 Pa (0.35 bar). As such, small atmospheric changes will have little effect (compared to effects on a normal airship envelope). The system 12 to accommodate this would be quite small, light and of low power consumption. This method may also serve as a means to adjust the buoyancy and accommodate the main envelope 1 gas volume changes by storing gas within the ring 2.

The upper stiffening ring 2 provides the main structure to support the other features. A secondary pressure means 13 to pressure stabilise the tubular form of the ring 2 will be necessary if it is of non-rigid form. Air may be used for this purpose, to avoid loss of the lifting gas from the main envelope chambers 1 & 3. This may be by an independent blower system 13 or via a valve and duct system to divert the flow (if there is primary blower redundancy). Pressure management of the stiffening ring 2 adopts similar methods to that for non-rigid airship envelopes, except that it must work at much higher pressures, so the blowers do not need to operate all the time (only to maintain pressure if the ring pressure falls).

The tubular ring 2 is fitted with internal bulkheads (not shown) that stabilise its form and which are used for attachment of other parts. Ballonets 14 also may be installed within the ring 2 to contain air for pressurisation. The upper ring 2 integrates with the thrust unit support structures 15 that are provided as hard structures, each with a pylon (not shown) to support the respective thrust units 16.

Integration of the tubular ring 2 with the hard structure 15 may be by simple clamp ring techniques. This is not the only way but is a simple and reliable technique known to work. The bulkheads within the ring 2 also may be of fabric materials and should freely allow the passage of gas (& people) between each cell. The ring 2 provides the mounting points for radial support ties 17 (of the suspension system assembly 10) that connect to a central vertical suspension line 18 (described later), and for mooring and handling lines 19, 20. The bulkheads within the ring 2 would be used to transmit load from the radial support ties 17 and the mooring & handling lines 19, 20.

The upper envelope assembly 1 provides the main chamber region for the lifting gas and is subject to gas pressure head only. As such it can be made from reasonably lightweight fabric, since it is not a main structural item. The upper ring 2 is used to carry such structural loads. In addition, the upper envelope 1 provides the mounting surface for solar energy collector panels 21. It is expected that the whole upper surface of the envelope 1 would be covered With solar panels 21, separated from the membrane 4 by an insulating layer (not shown) to reduce heating effects and to protect the envelope 1 from direct environmental effects.

After inflation, the upper envelope 1 is expected to be permanently filled with lifting gas due to natural effects that cause the gas to settle in the upper chamber. As such its shape is unlikely to alter very much, so should be stable and therefore suitable to mount the solar panels 21. A shallow domed shape with large radius is envisaged, since that is all that should be necessary to contain the lifting gas charge at ground level. If stiffening is required, then secondary inflatable radial tubes (not shown) extending from the main stiffening tube 2 and filled with the high pressure gas may be used for this purpose, providing ribs. However, it is unlikely that this will be necessary.

Electrical lines (not shown) from the solar panels 21 will be led away via conduit routes (not shown) around the main stiffening tube 2 to the thruster support structures 15, where it is expected that main electrically driven power system components and batteries (not shown) will be installed.

The membrane 5 of the lower envelope assembly 3 connects at its upper end to the outer surface of the stiffening ring 2 at a tangent position when inflated via a continuous gas tight joint similar to that of the upper envelope 1. Preferably, this joint is just below the stiffening tube's 2 equator position, such that the fabric weight hangs freely without causing peel effects and can wrap around the tube's 2 outer lower quarter segment. The lower envelope assembly 3 is usually almost, if not fully, collapsed at ground level. It provides the large expandable chamber region for the lifting gas to expand into and is only subject to gas pressure head effects when the lifting gas expands into it. As such it can be made from very lightweight fabric.

At ground level it is expected that the lower envelope 3 would be drawn in by atmospheric effects when lifting gas is compressed to its original volume by atmospheric pressure to resemble a dangling tail as shown in FIG. 3. This is normal, and will allow the main tail to be moved to one side as shown in FIGS. 1 and 2, further allowing the upper envelope 1 and main stiffening ring 2 to be held with its mooring lines 19 near to the ground (without affecting lower end features).

Thus, the lower envelope is effectively “sucked up” whereby the upper surface of the upper envelope is concave and the lower envelope is convex in shape.

The mooring lines 19 will connect at bulkhead positions to the main stiffening ring 2 between the upper and lower 4 and 5 membrane joints. These can be used early in the assembly of the vehicle and during inflation sequence, enabling in-field build arrangements without a hangar. Whilst twelve positions are shown, this is only illustrative (to show the principle). Although twelve is a reasonable number (providing redundancy against failures) the actual number of attachments should be decided according to the specific requirements, in use.

Ability to hold the vehicle close to the ground in a stationary manner and permit construction without a hangar are significant benefits compared with current airship practices. These aspects will aid deployment of the vehicle over wide regions, reduce maintenance costs plus difficulties and enable severe storm conditions to be endured. The arrangements also facilitate decommissioning for transport to another site or back to a hangar for repair work.

The shape of the lower envelope 3 when fully filled by the expanded lifting gas is expected to be a distended cone as shown in FIG. 5. Other shapes are possible, including completion of the upper envelope 1 profile to result in a sphere. This would affect the joint position and the placement of the trust units 16, but not the overall concept. Final shape may therefore be decided by the developer.

In some embodiments, the lower ring 7 is fitted at the lower edge of the envelope 3 to reinforce and maintain a constant circular lower edge profile, and provide means to interconnect via a tensioning line system 11 with the payload capsule 9. The payload capsule 9 is itself supported via an independent suspension system assembly 10 from the main stiffening ring 2, obviating effects due to lifting gas expansion and contraction. Arrangement of the suspension system assembly 10 is as follows.

Radial support ties 17 (FIG. 6), similar in concept to the spokes of a bicycle wheel, extend from the bulkhead connection points of the main stiffening ring 2 to an upper central hub 22. From there, a long vertical suspension line 18 descends to a lower support hub 23 above the capsule 9. Short suspension lines 24 descend from the lower support hub 23 to connect the capsule 9 at its interface points. Conduit may also follow this route to provide necessary power, signalling and control over the upper mounted systems thus guaranteeing that line lengths can be maintained. The tensioning lines 11 attached to the lower ring 7 are connected to the capsule 9 via a spring reel (not shown) mounted on the capsule 9 to enable them to be retracted, thereby to pull gently the lower ring 7 into position on top of the capsule 9.

The gaiter 8 connected between the lower ring 7 and the hub 23 allows for vertical movement of the ring 7 relative to the hub 23. This is necessary since, when the lower envelope 3 collapses due to contraction of the gas as the vehicle descends, it is expected that the lower envelope 3 will draw up as shown in FIG. 3. In reverse, as the vehicle ascends the lower envelope 3 will extend downwards as shown in FIG. 4 until the lower ring 7 sits on the capsule 9. It will then fill out as further gas expansion occurs. These simple features should maintain alignment in a stable way, freely allowing the shape of the lower envelope to change without affecting the capsule's suspension or control and signal lines' length (between the capsule and upper envelope), yet providing a secondary load path for capsule support and stabilisation under abnormal circumstances.

Vertical load from the payload capsule 9 is carried to the upper central hub 22 and thence via the shallow angled radial support lines 17 to the stiffening ring 2. With a shallow angle, a single line 17 from each side to support the central vertical line 18 would generate high load. However, by utilising several pairs of support lines 17 in such a radial fashion the load may be spread equally between them, enabling a high vertical suspension load to be supported centrally without high loads being generated in the upper support lines 17. Each support line 17 therefore applies an inward load on the stiffening ring 2 that must be reacted. The load initially is carried by the bulkheads of the stiffening ring 2, which in turn transfer the load in shear and tension to the stiffening ring tube 2. The radial loads cause compression across the section of the stiffening ring 2 that resists the line 17 forces. As a flexible fabric structure, this compression is resisted through the stiffening effect of its pressurisation, thus enabling the support without significant change to the overall geometry.

A further additional feature that may be considered is the addition of a rigid pole (not shown) from the upper central hub 22 vertically upwards through the mid point of the membrane 4 of the upper envelope 1. If the membrane 4 is provided with fittings and a gaiter (not shown) at this position to seal the penetration, the pole may be held from toppling by the membrane 4 and used as a mast mounting above it for other purposes. Such purposes could be to: mount instrumentation, a flag, lights, lightning protection facilities, observation cameras, a telescope, an upper protection canopy (perhaps, whilst moored, to keep snow off the solar panels or to use as an insulation layer to maintain an even gas temperature through day and night), transmitter/receiver equipment, a radar antenna. Vertical loads from the pole would be carried by the suspension system 10. The axial feature may also be used as a route for conduit lines.

As described above, the lower envelope 3 at its bottom edge is terminated by a ring 7. This leaves the envelope 3 open at the bottom with the possibility that the expanding lifting gas in the space bounded by the lower membrane 5 could be vented. Whilst this is unlikely, the aperture should be closed by a further fabric gaiter 8 (conically shaped) and fitted between the envelope's lower ring 7 and the capsule suspension system's lower hub 23. This gaiter 8 would flex inside out and back again as the lower envelope 3 moves up and down respectively. The gaiter 8 also would need a non-flexible portion next to the support hub 23 for bulkhead connectors (to enable the control and other conduit lines to pass through).

It will be appreciated that the capsule 9, with its payload and necessary systems will be reasonably heavy and is under slung at a very low position below the upper structure 1, 2, 3. Also, the lower envelope 3 provides weight that is fairly low. These masses should provide strong pendulum stability to keep the essentially lenticular upper structure shape (when at low altitude) from behaving aerodynamically in an unstable manner. When the lower envelope 3 fills out (at high altitude) this would no longer be a problem. Nonetheless, if it is found to be a problem, further lines (not shown) could be installed directly between the main stiffening ring 2 and the capsule 9 to obviate any flexure of the lower envelope—forcing the whole arrangement to behave as a single body. Alternatively, the long handling lines 20 could be connected to the capsule 9 to undertake this function.

The handling lines 20 can be extension parts connected to the lower ends of particular mooring lines 19 that enable the vehicle to be restrained whilst fully extended (as shown in FIG. 3). This normally only would be prior to a launch or after capture. The lines would be used with winch gear (not shown) to haul down or let up the upper inflated structure 1, 2, 3 against buoyancy to a height where the mooring lines 19 may be connected as shown in FIG. 2. When properly secured by all of the mooring lines the capsule 9 and lower envelope 3 tail should be carefully moved to one side out of the way. The upper inflated structure 1, 2 should then be hauled right down to its lowest level and re-secured by the mooring lines 19 (as shown in FIG. 1) to hold it safely against adverse weather.

Capture (the recovery action, when the vehicle is first caught by the ground crew and connected to a ground anchor) and Launch (the release action, when the vehicle is finally let go by the ground crew from its last anchor point) are facilitated by a single line 25 below the capsule 9. This line 25 is used to pull down the floating vehicle to the ground and then tie-off to hold it in position. This action probably can be undertaken using manpower effort assisted by the vehicle thrust units 16 and will require a central mooring site anchor fitted with a ring (not shown) to pass the cable through and a tie-off point-to one side (not below the capsule), which also can be a ring on a ground anchor. Once captured, the handling lines 20 would be connected followed by haul down of the upper structure 1, 2, as described above. When restrained by the handling 20 and mooring lines 19 the recovery/release line 25 would be disconnected from the anchors to permit movement of the capsule 9 to its side parking position.

If needed, for whatever reason, the recovery/release line 25 also may be used to move the vehicle to a new position using a floating technique, where the vehicle is connected to a heavy surface mover (tug or tow vehicle) then ballasted to a light condition (where buoyancy exceeds gross weight) to maintain line 25 tension and finally towed to its new position. This could be necessary if the vehicle is unable to return to its ground station for recovery purposes. The handling lines 20 also may be used for this purpose with additional surface movers to provide restraint during the transit.

The recovery/release line 25 also must be able to discharge static electricity from the vehicle to ground.

The payload capsule 9 is the housing for the payload and the vehicle's main systems, such as: Electrical, Control, Avionic, Pressurisation, Fire Detection and Suppression, Environmental Control, Auxiliary Power, Ballast and Miscellaneous Equipment. These are all typical of airship and other aircraft installations, so do not need elaborating in any detail here. It is expected that existing technology would be adapted and used to fulfil the needs. The payload capsule 9 itself is envisioned to be constructed as a vertical cylinder with dished upper and lower end caps, as a pressure vessel. It would be provided with a floor, ceiling, windows, doors and interface positions suitably reinforced and stiffened as necessary to suit the purpose. It is expected that it may need to be pressurised to provide the necessary environment for the payload.

Since the payload capsule 9 could be damaged when the vehicle returns to the ground, fenders (not shown) would be necessary. Various brown types of fender may be used, such as: bumper, pontoons, wheeled shock absorber legs, skids, etc, to suit the operational circumstances. The preferred choice is a sprung skid arrangement (not shown) at three positions around the capsule 9 that use a large rotating dish as the skid (similar to some castors) and acting as legs to support the capsule 9.

For control of the vehicle ducted propeller thrust units 16 driven by electrical motors behind a propeller are used. The propeller itself should have variable blade pitch angle control to enable varying amounts of thrust both forward and rearwards to be developed. This also will be necessary to suit the different environments from sea level to the stratosphere and to provide precise control, particularly during launch and capture.

Power for the motor would be drawn from the electrical installations housed in the thrust unit support structure 15, as discussed above. Additional small and self contained auxiliary power units (not shown) may also be installed in the thrust unit support structures 15, to overcome short term needs if the solar panels 21 and their accumulators (batteries) are unable to provide sufficient supply (perhaps at night).

Whilst just two thrust units 16 are shown in the figures, the minimum for correct functioning, further units could be installed (improving failsafe aspects). This however, does not alter the concept. These arrangements are similar to those already developed for other uses—except that they must be able to perform adequately in the stratosphere.

In order to control the vehicle in any direction each thrust unit 16 would be provided with a vector system (not shown) to rotate the duct for alignment of the thrust, as desired. Several airships and other aircraft have used such mechanisms for similar purposes, so this does not need to be elaborated.

In addition to thrust control other controls will be necessary, such as:
ballast dump—to reduce weight
helium valves—to reduce aerostatic lift
envelope rip or holing system—to destroy aerostatic lift

These are standard airship features, the particular arrangements of which will be within the scope of knowledge of persons skilled in the art.

Navigation lighting (not shown) and a transponder (not shown) will also be necessary, to comply with the Air Navigation Order. These are mandatory, the particular arrangements of which will be within the capabilities of persons skilled in the art.

At the height of operation in the stratosphere, the vehicle is unlikely to be a hazard to most aircraft. It probably will not have an easily detectable radar signature, so the vehicle should be provided with a radar reflector to enable tracking if circumstances (such as total power failure) could occur where the transponder and GPS system cease to function. If total power failure does occur, as an LTA vehicle, it should continue to float in the stratosphere but will drift with the prevailing air currents. Ultimately, the vehicle will need to be brought down under controlled circumstances and before conditions deteriorate—causing it to come down unexpectedly. Emergency backup batteries therefore should be provided that have the sole purpose of providing power to operate those systems necessary to bring the vehicle down under controlled conditions.

To bring the vehicle down under these circumstances it will be necessary to operate a valve to release some of the lifting gas, so that it will descend due to static heaviness (when gross weight exceeds buoyancy). A means to arrest the descent by opening another valve to dump ballast, making it statically light, also will be necessary. Finally, when it is known that it can descend safely to a suitable resting place a means to release quickly all of the gas will be necessary so that it does not take-off again or drift across the ground. A means to hole the envelope should be provided for this purpose. Clearly the vehicle will need to be recovered from its final resting place. If the descent procedure is undertaken with due care, there will be no permanent damage and the vehicle plus the payload should be able to be recovered intact for subsequent operation.

The diaphragm 6 is a disc (circular membrane) of light gastight material (envelope fabric) that connects continuously to the inner facing wall of the main stiffening ring 2 (probably at its equator level) at a position just above the capsule suspension system's 10 radial support lines 17 to close off the upper chamber 1.

In order to get into the upper 1 and lower 3 chambers, suitable manhole positions plus aperture reinforcements will be needed in the upper envelope 1 and inflation diaphragm 6. These must be closed and sealed before lifting gas inflation.

If the suggested upper mast pole is to be adopted this also should be installed, plus any associated systems it is intended to carry. The inflation diaphragm 6 will be needed for subsequent lifting gas fill operations, so a means to connect the pole to the upper support hub 22 with the diaphragm 6 between that can be sealed will be necessary. Also, when the air is exhausted from the various chambers 1, 2, 3 prior to gas inflation, the upper envelope 1 needs to be able to collapse completely without restriction from the pole. A sealing sleeve from the upper envelope penetration fitting to the upper support hub will be needed for this, also enabling the pole to be removed without gas loss.

When all the inspection, correction, assembly, and checkout work has been completed, preparations for gas inflation should be undertaken. Air does not need to be exhausted from the lower chamber 3, since this can be a useful cushion to support the upper envelope 1, so the manhole in the inflation diaphragm 6 should be finally closed. Following this, plus the removal of all equipment and personnel from inside, all air should be evacuated from the upper chamber 1 and the main stiffening ring 2, as necessary, causing the assembly to collapse flat against the ground (except for the cushion of air trapped in the lower envelope chamber 3).

Following removal of the ground blower system tubes all apertures and manhole positions must be finally closed. It will be useful if these apertures are provided with sleeves that can be quickly tied off to arrest any flow before installing the covers. Lifting gas inflation preparations should follow.

The lifting gas may be helium or hydrogen depending on circumstances of acceptability. Hydrogen is a highly inflammable gas whilst helium is inert. However, helium is a rare gas that is very expensive and does not provide such good lift characteristics as hydrogen.

When the lines 19, 20 to restrain the vehicle have been checked and adjusted to suit, the gas plant positioned, the inflation pipes connected to the upper envelope 1 and the main stiffening ring pressurisation system 12 primed (ready to transfer gas from the upper chamber to fill the tube 2), gas inflation may commence. Gassing should proceed at a steady rate whilst monitoring the behaviour. It is expected that a bubble will rise from the upper envelope and gradually spread out until the upper chamber 1 is filled. In addition, as gas transfers to the main stiffening ring 2 this also should rise until it is full. When the upper envelope 1 is filled, the plant may be disconnected and removed. A small reserve of gas should be kept at the site for subsequent topping up. Monitoring of the system (pressure watch) will be necessary from this time onwards. Also, tension in the mooring lines 19 will have increased; so this should be checked and adjusted to maintain a balanced system.

Inflated with its lifting gas (trapped in the upper chamber 1 by the inflation diaphragm 6) subsequent operations that require work inside the lower envelope 3 may be safely conducted in an air environment. The inflation diaphragm 6 should function as a ballonet membrane to accommodate gas expansion through its distension. Otherwise, pressure may be increased in the main stiffening tube 2 to draw off gas from the upper chamber 1. Buoyancy may now also be used to raise the upper structure 1, 2, 3 for subsequent work.

Completion of assembly work should follow with installation of the thrust units 16, followed by functional checkout of the systems involved. If the structure 1, 2, 3 needs to be raised for this then the handling systems 20 should be used to do this, allowing buoyancy to lift the upper structure 1, 2, 3 to the height desired as the lines 20 are paid out. Also, if the solar panels 21 were not installed this should be completed. When assembly work is complete the upper structure 1, 2, 3 may be let up sufficiently, restrained by the handling lines 20, to enable lower end work to be undertaken.

The payload capsule 9 is a self contained system the assembly work of which can be undertaken in parallel with the envelope 1, to inflation, so that it is ready for integration when the envelope 1, 2, 3 work is complete. It also is envisioned that the capsule 9 would be factory completed to a fairly high degree before site delivery. Delivery of this capsule 9 is expected to be on a maintenance cradle that can be removed after the ground fenders are installed. After installation of the fenders and removal of the cradle, the capsule 9 should be able to be freely moved and be free standing on the fender legs without need for anything further.

After the system has been let up, the lower envelope 3 (open at this stage at the bottom) and the payload capsule vertical suspension line 18 will hang down freely in a natural way from their upper attachments—the lower envelope 3 partially filling with air through the bottom aperture. When things have settled, inspection of the lower envelope 3 to the height previously unchecked internally/externally for pin-hole damage, basic integrity and conformance should follow. Any non-conformance aspects should be corrected before closing the lower aperture. To facilitate this work the structure should be gradually lowered or raised using the handling restraint line 20 winches so that work can be conducted at ground level.

Final assembly work, to fit the lower end components and interconnect with the payload capsule 9, is the last thing to do to complete the vehicle. After installing the suspension system lower support hub 23 and the payload capsule suspension lines 24, using clamp plates, the lower envelope 3 bottom edge ring 7 and the conical closing gaiter 8 should each be installed. The payload capsule 9 can then be connected to the suspension system 10 via its lower lines 24 and the lower envelope interconnected by the tensioning lines 11. System and control lines finally may be connected to complete the vehicle.

At this stage the lower envelope 3 will be partially full of air that needs to be evacuated. Before this is done, a leak and proof pressure test of the lower envelope 3 using air should be conducted to demonstrate integrity for operation. The ground blower therefore needs to be installed and used to fully inflate the lower envelope chamber 3 with air and to pressurise it. This check also will enable the final fit to be assessed—to determine that the arrangements will function correctly during operation. Air put into the lower envelope 3 will not mix with the already gas inflated upper chamber 1 because of the inflation diaphragm 6. This diaphragm 6 also will keep the gas from escaping when the lower envelope 3 is evacuated.

Having checked the lower envelope's 3 integrity, the ground air blowers should then be set in reverse to evacuate all of the air from the lower envelope chamber 3. During this stage the lower envelope 3 will draw together and rise (as shown from FIGS. 1 to 3) due to atmospheric pressure action. As the air is evacuated the arrangements should be checked to determine that the gathering and rising action occurs as expected, without causing any problems. Following air evacuation, the ground blower system should be removed and the aperture finally closed. For convenience this aperture should be near the bottom of the lower envelope 3, be fitted with a sleeve (used to close it) and be of a flexible reinforced type with fabric covers that are then tied together to keep the sleeve inside.

At this point the vehicle is nearly ready for operation. However, before this is undertaken, the inflation diaphragm 6 either must be removed or a means to allow the lifting gas to expand into the lower chamber 3 must be provided. Removal will be awkward to undertake and, although it enables weight to be saved, could be a useful feature for future use. Uses could be as follows:
As a secondary container membrane to prevent all of the lift gas being lost should there be leakage from the upper envelope 1—a possibility if a dump valve were to stick or fail in the open position.
As a means to raise the upper compartment pressure—a need may exist for this if the gas head is insufficient to stabilise the upper envelope 1 membrane 4 for a) maintenance activities (to allow people to walk on the upper envelope 1) or b) operational reasons (if it is found that a higher pressure is needed).
For future maintenance and inflation purposes.

If, for these or other reasons, the inflation diaphragm 6 remains as a permanent feature then it will need valves that can be remotely operated to open and to remain open through operation until deliberately set to close. Indeed, the failsafe action for these valves should be that they would only fail in the open position. This will then permit the free expansion of the gas. Sizing, position, method of operation and number of valves will be for the developer to decide. Also, procedures for the use of these valves will be necessary to ensure there is free passage for the gas to pass through between the upper 1 and lower chambers 3.

To launch the vehicle the following outline procedure will be necessary.

It is assumed that the vehicle is in its fully moored position as shown in FIG. 1 with the payload capsule parked to one side. If not already inflated fully with lifting gas, chamber 1 is topped up with lifting gas pumped under pressure into the upper chamber 1. If not already evacuated the lower chamber 3 is evacuated of air as described above. The mooring lines are released in a controlled way and as the vehicle ascends under remote control from the ground it is flown to a desired geostationary location. During ascent and descent the venting means in diaphragm 6 are controlled to allow lifting gas to expand into the lower chamber 2 or contract into chamber 1.

Recovery of the vehicle largely is a reversal of the above procedure, so does not need to be elaborated in detail here. In general terms, the ground pilot will set-up the vehicle for its descent applying normal LTA practices and bringing it to an overhead position above the mooring site. Prior to capture, a weigh-off will be conducted to set the state of equilibrium (static heaviness or lightness) for capture. Whilst the ground pilot controls position and height of the vehicle relative to the mooring site the Crew Chief will coordinate and control ground operations. After touch down of the recovery/release line 25 (to discharge static electricity) a crew member will collect the line 25, connect it through the ground anchor ring at the centre of the mooring site, lead it out and then tie it off at its side restraint position. At this point the vehicle is ‘Captured’ as shown in FIG. 3, but without the handling lines 20 connected, and the Crew Chief assumes control for subsequent actions.

Referring to FIGS. 7 to 12, a second embodiment of the invention is illustrated in which the aircraft is a hybrid LTA vehicle. It comprises the following main assembly, modular or system features, namely lifter 101, a main under-slung working module 102, rigging 103, lifter management system 104 and a payload suspension plus containment system 105.

The lifter 101 comprises a lifter body comprising a lifting gas containment envelope 106 having upper and lower surfaces that, at least when the envelope 106 is inflated, are of curved profile. The lifter 101 includes thrust unit and aerodynamic lift system configurations107, 108 (FIG. 11) respectively. In the drawings the envelope 106 is shown as being of lenticular shape when viewed in elevation, but it could be spherical or other curved body of revolution shape (such as pumpkin).

The lifter body has a large diameter tubular ring 109 that provides a stiff chassis and constitutes a consistent main mounting structure able to hold its shape for the other parts. A similar ring also is utilised by the aircraft according to the first embodiment described above. The aircraft of this embodiment may be configured for stratospheric applications.

A secondary means to pressure stabilise the tubular form of the ring 109 will be necessary if it is of non-rigid form. Air may be used for this purpose, if desired, but the lifting gas would help to negate the weight of the ring 109. It is not, however, intended that the ring 9 be the main chamber for lifting gas containment.

The tubular ring 109 also is fitted with regular bulkheads (not shown) that stabilise its form and which are used for attachment of other parts. It also integrates with the Thrust Unit Support Structures 110, provided as hard structures, each with a pylon (not shown) to support the respective thrust units 107. The thrust units 107, however, are mounted at different positions and normally utilised only for lateral translation both in the fore or aft directions and in sideways directions, and for steering (rotational control about the vertical yaw axis) or steadying purposes. In addition, the stiffening ring 109 provides the mounting base for an aerodynamic lift system 108, described later below.

Integration of the tubular ring 109 with the thrust unit hard structure 110 may be by simple clamp ring techniques. The bulkheads also may be of fabric materials and should freely allow the passage of gas (and people) between each cell. The bulkheads also would be used to transmit load from the rigging arrangements 103 (FIG. 9) that restrain the aerostatic gas lift.

The envelope 106 also comprises an upper envelope assembly 111 and a lower envelope assembly 113. The upper envelope assembly 111 comprises an upper membrane 112 that connects to the upper surface of the stiffening ring 109 at a tangent position (see FIG. 9) via a continuous gas tight joint (adhesively bonded or welded). A clamp plate method (similar to envelope penetration reinforcement clamp rings) also may be used to make the joint, which will be necessary if a rigid stiffening ring is adopted.

The upper envelope assembly 111, which is arranged to provide the larger part of the main chamber for the lifting gas, is subject to moderate gas pressure levels to stabilise its membrane 112. As such it can be made from reasonably lightweight fabric, since it is not a main structure feature (the stiffening ring 9 is used to carry such loads). In addition, the upper membrane 112 can be used to provide the mounting surface for solar energy collector panels (not shown), if desired for power generation purposes. It is envisioned, however, that more conventional motor driven power generation systems would be utilised.

The lower envelope assembly 113 has a membrane 114 that connects to the lower inside surface of the stiffening ring 109 at an approximate (depending on viewing point) radial 5 or 7 o'clock position (when inflated) via a continuous gas tight ‘T’ joint (see FIG. 9). This is not the only position for lower envelope attachment, which depends ultimately on the thrust units' 107 configuration.

The lower envelope 113 is approximately symmetrical to the upper assembly 111 of the lifter body 106 main lifting gas chamber and with a similar curved profile to the upper membrane 112. The difference between the upper and lower assemblies 111, 113 of the envelope 106 resides in their connection position on the stiffening ring 9. In addition, the lower assembly 113 is provided with a ballonet 113(a) for gas expansion accommodation and pressurisation purposes—similar to non-rigid airship envelopes. It also may be manufactured from lighter weight fabric compared with the upper membrane 112, since it is not subject to such high gas pressure as the upper part of the envelope 106, due to gas pressure head effects.

The ballonet 113(a) is a dished membrane for air containment attached concentrically at its outer edge to the inner side of the lower envelope membrane 114 (as part of the lower envelope assembly 113), which (when empty) lies against the membrane 114 but (when filled with air) rises and inverts to an opposite bubble shape (when full).

The upper 111 and lower 113 assemblies together with the main stiffening ring 109 provide an overall essentially lenticular shaped gas containment envelope 6 (the lifter body) that has two chambers, namely:
the tubular ring (stiffened with high pressure) and
the main envelope chamber 106 (stiffened with low pressure) between the upper and lower envelope assemblies 111, 113 and closed by the inner wall of the ring 109.

The lifter body therefore has a stiff outer lower shoulder and outer equator rim 109 used to mount other aircraft features. The lenticular form enables overall aircraft height to be reduced (as shown from FIG. 7 to 9) when moored and provides a low drag solution unaffected by wind direction during flight and whilst moored.

The shape of the lifter body is expected to be constant and it is preferred that it is lenticular when viewed in elevation (as shown in the drawings). Other shapes are possible, including other curves of revolution such as, for example, a profile that results in a sphere. This would affect the joint positions between the membranes 112, 114 and the ring 109, overall height and aspect ratio of the envelope 106, and the placement of the thrust units 107 and aerodynamic lift system 108, but not the overall concept. Final shape of the envelope may, therefore, be decided by the developer. It should be noted, however, that other shapes will also affect the ability of the aerodynamic lift system to generate adequate lift, since it is an interactive system that uses the presence of the lifter body to generate lift. Other shapes will affect such performance.

The lifter 101 is provided with an aerodynamic vertical lift system 108 as part of the means to carry and transport the payload. The aerodynamic lift system is shown in greater detail in FIGS. 14 to 16.

Referring to FIGS. 14 to 16 the aerodynamic lift generator 108 is similar to a very large fan in appearance, and has aerofoil blades 120 (only one of which is shown in FIG. 8), equispaced around the circumference of the envelope 106, that rotate around a hub. The blades 120 are stub (low aspect ratio) wings each of which is mounted on a torque tube 121 retained for pivotal movement about its longitudinal axis in a rotatable rigid ring 122 that is able to rotate on rollers 123 held in sleepers 124 that constitute a track way provided on the outer face of the lifter body's stiffening ring 109, which effectively acts as the hub, and, of course, is of exceptionally large diameter.

The upper part of the rigid ring 122 accommodates a plurality of pinion gears 125. There is one pinion gear for each blade 120. Each pinion gear 125 engages with a rack 126 on each torque tube 121, so that rotation of the pinion gear 125 alters the pitch of the blade 120. The pinion gears 125 of each stub wing 120 are interconnected by a flexible torsion shaft (not shown) independently supported by bearings and universal joints around the rigid ring 122 to ensure synchronisation and collective movement of each blade 120. This torsion shaft is driven independently at say 4 equispaced positions around the ring 122 to control the pitch attitude of the stub wing 120.

Aerodynamic lift is expected to be generated in two ways. Firstly, by flow over the rotating blades 120, which will cause a vertical annular draft around the envelope 106. Secondly, due to secondary effects, by core air flow that is induced to flow with the vertical annular draft, itself caused to flow by the impeller action of the stub wings 120 as they rotate around the lifter body 106. The incident core air flow is forced to move radially outwards by the presence of the envelope 101 over its incident curved surfaces 112 or 114 (depending on flow direction) and then separates from the lifter body on the outwash side, thereby generating aerodynamic lift from the pressure distribution that results on the envelope 106. The direction of the vertical flow and thus lift is determined by the pitch of the blades 120. A significant proportion of the total lift is expected to be due to air flow over the incident curved surface 112, 114 of the envelope 106.

Rotation of the blades 120 may be undertaken in a variety of ways:
by thrust units mounted on the stub wings 120 or the rigid ring 122
by an electrical linear motor system between the rigid ring 122 and the fixed sleeper tracks 124,
pneumatically by an air jet system between the rigid ring 122 and the fixed sleeper tracks 124,
by a mechanical drive system between the rigid ring 122 and the fixed sleeper tracks 124,
by jet efflux at the trailing edge of the stub wings 120.

Similar methods for motivation and the track arrangements that could be used in the present invention are used in other industrial applications so do not need any elaboration here. In this respect, the aerodynamic lift system 108 is a new feature for aircraft.

The preferred plan form of the envelope 106 is a circular shape because this simplifies the mounting and drive mechanism for the aerodynamic lifter 108. However, it may be possible to make the envelope 106 of an oval, ogival or elliptical shape in plan. In this case, it would be necessary to mount each blade 120 (and it's associated torque tube 121) on a carriage (not shown) that is connected to adjacent carriages around the perimeter of the envelope 106 to form a driven part of a linear electric motor that functions to propel the blades around the periphery of the envelope 106. It may be possible to develop an alternative system similar to a conveyor belt type of drive.

Other methods for such air circulation control to generate aerodynamic lift, such as “blown slot” techniques may be incorporated to augment the aerodynamic lift system 8. In this case the upper and lower membranes 112, 114 may incorporate a plurality of air discharge nozzles from which pressurised air flows issues thereby to induce air to flow radially outwards over the incident upper or lower surface 112, 114 and improve lift in a similar way to that used in so called blown slot or blown wing designs. Similarly it may be possible to generate aerodynamic lift using electro-kinetic lift methods, whereby through the use of electrostatic effects an air circulation flow results over the incident surface 112, 14 that causes aerodynamic lift.

Such methods are interesting, since they do not necessarily involve any moving parts—so might be configured more simply. The methods are new and potentially of great benefit but so far have little accreditation. Whilst such methods may be used to supplement or augment the aerodynamic lift system 108 described above, it may also be possible to replace the aerodynamic lift system 108 with an electro-kinetic system, or a system of air discharge nozzles through which pressurised air issues so as to induce an air flow over the respective incident curved upper or lower surface 112, 114, or with a combination of both electro-kinetic and blown nozzles.

Referring to FIGS. 7 to 11, the rigging 103 comprises the working module suspension system 115 plus mooring/handling lines 116. The various rigging lines 103 connect at bulkhead positions to the main stiffening ring 109 between the upper 111 and lower 113 envelope joints. These lines 103 can be used early in the aircraft assembly and inflation sequence, enabling in-field build and inflation arrangements without a hangar.

The mooring/handling lines 116 are each of the same long length—to enable haul down against the much greater aerostatic lift from the main chamber (filled with gas to a much greater extent). Also the working module suspension lines 115 are arranged to interconnect directly between the main stiffening ring 9 and the working module 102. They also should have lockable release facilities from the working module 102 so that they can be used for storm mooring purposes as well.

Whilst twelve rigging line 103 positions are shown, this is only illustrative (to show the principle). However, although twelve is a reasonable number (providing redundancy against failures), the actual number of attachments should be decided from according to particular requirements.

The rigging arrangements allow the working module 102 to be moved to one side, as shown from FIG. 8 and FIG. 9, further allowing the lifter 101 to be held near to the ground (without affecting lower end features). Ability to hold the lifter close to the ground in a stationary manner and permit construction without a hangar are significant benefits compared with current airship practices. These aspects will aid deployment of the aircraft over wide regions, reduce maintenance costs plus difficulties and enable severe storm conditions to be endured. The arrangements also facilitate decommissioning for transport to another site or back to production facilities for repair work.

The working module itself 102 is supported via an independent suspension system 115 from the main stiffening ring 109, obviating effects due to lifting gas expansion and contraction. Suspension lines 115, in plan similar to the spokes of a bicycle wheel, extend down from the main stiffening ring's bulkhead connection points directly to releasable attachment parts (not shown) on the upper edge of the working module 102. Conduit may also follow these routes (although a centralised route discussed latter is recommended) to provide necessary power, signalling and control over the upper mounted systems—guaranteeing that line lengths can be maintained.

Rigging line parts 103 may be made using existing materials and parts that generally are stock items, although some parts (such as attachment brackets) may need to be developed to suit. Careful attention to the selection of materials and the detail arrangements will be necessary to avoid damage due to lightning strike attachments. Nonetheless, development and construction would follow normal aircraft practices, so do not need elaborating in any detail here. The particular arrangements will be for the developer to undertake/decide.

Whilst suspension systems in many other applications use similar parts, the particular arrangement here is a new concept, enabling independent support from the main stiffening ring. Vertical load from the working module 102 is carried directly to the stiffening ring. Each suspension line applies an inward load on the stiffening ring 109 that must be reacted. The load initially is carried by the stiffening ring's bulkheads, which in turn transfers the load in shear and tension to the stiffening ring tube. The radial loads cause compression across the section of the stiffening ring that resists the line forces. As a flexible fabric structure, this compression is resisted through the stiffening effect of its pressurisation, thus enabling the support without significant change to the overall geometry. Vertical load from the suspension lines is carried by the aerostatic and aerodynamic lift methods of the lifter 101.

The working module 102, with its payload and necessary aircraft systems will be very heavy and is under slung at a very low position from the lifter 101. Most of the weight will result from ballast (if there is no payload), to counteract the gas lift (buoyancy), or result from a combination of ballast and payload. This mass should provide strong pendulum stability to keep the essentially lenticular lifter body 106 from behaving aerodynamically in an unstable manner.

The handling/mooring lines 116 enable the aircraft to be restrained at its full height (as shown in FIG. 7). This normally only would be prior to a launch or after capture. The lines 16 would be used with winch gear to haul down or let up the lifter 101 against buoyancy to heights where the suspension lines 115 may be connected/disconnected (as shown in FIG. 8) or take up load (as shown in FIG. 7). When properly secured by all of the mooring lines (as shown in FIG. 8) the working module 102 should be carefully moved to one side—out of the way. The lifter should then be hauled right down to its lowest level and additionally secured by the suspension lines (as shown in FIG. 9) to hold it safely against adverse weather.

Capture and Launch are facilitated by a single line 117 below the working module 102, in like manner to the first embodiment, so shall not be described in any greater detail.

The recovery/release line 117 also may be used as an alternative or under abnormal circumstances, as a mooring line. In this case a longer retractable line would be connected, enabling the aircraft to be let up under static light conditions to a higher position (as a tethered aerostat) where it can then freely ride the weather circumstances without excessive line loads.

The recovery/release line 117 also must be able to discharge static electricity from the aircraft to ground.

The aircraft, however, may utilise additional or alternative automated facilities in these processes to help overcome problems due to shear size and the resulting high forces that must be managed. The aircraft, by virtue of its payload carriage method, already will have a strong line beneath the working module suitable for such restraint purposes—normally used to carry the payload as an under-slung package. This line also may be extendable via a winch system affixed below the working module and be provided with a lower hook. Since during launch or capture the aircraft would not be transporting a payload, this line may be used for the recovery/release action in a manner similar to that described above but simply connected to a central restraint point. The aircraft under its own power may then draw itself down or let itself up using the winch facility to a position that is safe for ground crew personnel to connect/disconnect the line.

If desired and to avoid danger to ground personnel working below the aircraft, this last line connection/disconnection process to the central mooring site restraint point also may be automated. If, instead of a simple hook at the lower end of the line an automated calliper jaw mechanism is provided, then the pilot could utilise this to undertake the operation unaided. Precise control of the aircraft and visual plus sensing systems would be necessary to assist the pilot in this operation. The automated system also would be useful for pickup and delivery of pre-packaged payloads.

Alternatively, the automated capture mechanism could be a facility installed and operated on the ground at the central mooring site position. A simple pendant fitting on the end of the line would then be all that was necessary. The mechanical arrangements utilised would be for the developer to decide.

Referring to FIG. 7, the working module 102 is the main housing for the aircraft's primary systems, such as: ballast 130, pressurisation 131, electrical 132, control 133, avionics 134, fire detection and suppression 135, environmental control 136, auxiliary power 137 and miscellaneous equipment 138. These are all typical of airship and other aircraft installations, so do not need elaborating in great detail here. It is expected that existing technology would be adapted and used to fulfil the needs and this will be for the developer to undertake/decide.

The working module also provides environmentally controlled facilities for the crew. It is envisioned that the working module will comprise three main sub-modules, as follows:
systems capsule 140,
pilots' command and control capsule or cockpit 141,
lifter systems' module 142.

The systems capsule 140 is the main vessel for containment of the aircraft working systems 130 to 138 and provides housing for crew furnishings, equipment and essential facilities. It would have two main levels:
an upper floor region for the mainly dry systems and personnel facilities,
A large lower tank level for necessary ballast water containment.

It is envisioned to be constructed as a vertical cylinder with dished upper and lower end caps, as a pressure vessel. It would be provided with a mid level floor, upper ceiling, upper level windows and doors, lower level integral water tanks plus central vertical access shaft and interface positions suitably reinforced/stiffened as necessary to suit the purpose. It is expected that it would need to be pressurised to a low level to provide the necessary environment for the systems and personnel aboard. Its development and construction would follow normal aircraft practices, so do not need elaborating in any detail here. The particular arrangements will be for the developer to undertake/decide.

The cockpit 141 is an under-slung turret below the systems capsule 140, which provides the housing for the pilots plus their controls, instruments, displays, etc. It also is envisioned to be constructed as a vertical cylinder with a dished bottom cap, as a pressure vessel. It would be provided with a floor, windows and door suitably reinforced/stiffened as necessary to suit the purpose. Its development and construction would follow normal aircraft practices, so do not need elaborating in any detail here. The particular arrangements will be for the developer to undertake/decide.

The lifter systems module 142 is a unit that sits atop the systems capsule 140 to house the blowers and valves plus other systems necessary for pressurisation and management of the lifter as an inflated structure. These systems are typical of aerostat installations, so do not need elaborating in any detail here. The particular arrangements will be for the developer to undertake/decide.

The lifter management system 104, comprises the systems in the lifter systems module 142 together with a fabric umbilical trunk 143 between the lifter systems module 142 and the lower envelope surface 113 plus conduit lines from the lifter systems module to their respective lifter positions and associated passages (not shown) in the lifter.

The fabric umbilical trunk 143 provides for the passage of air (contained in the ballonet compartment) to regulate the main envelope chamber super pressure. The trunk also should be provided with means for maintenance personnel to use it as a passage for access into the lifter's ballonet 113(a) compartment.

It should be noted that normally aerostat pressurisation and management systems are mounted directly below on the underbelly of the respective aerostats that they serve and that the air valves, which release air from the ballonet, are mounted on the lower envelope. Grouping them together in the lifter systems module 142 atop the systems capsule 40 and using the fabric trunk 143 is a new method that facilitates maintenance without the need for high reach equipment. Indeed, access to the lifter systems module 142 and subsequent access to the lifter 101 plus its systems and parts via the fabric trunk 143 and subsequent air passages is possible during flight if the developer chooses to adopt such arrangements.

The fabric trunk 143 plus sealable air passages (not shown) from the ballonet 113(a) compartment to the stiffening ring 109 would also be utilised as the main conduit route for electrical, control, signalling and other lines. In this way inspection, maintenance or repair may be attended to at any time.

Self contained power units 144 should be installed on top of the systems capsule 140 to provide power mainly for the working module systems and the payload package 105. A minimum of two independent units, each able to provide the necessary power is desirable for redundancy and to facilitate maintenance.

Since the working module 102 could be damaged when the aircraft returns to the ground, fenders 145 similar to those outlined above.

For horizontal and yaw control of the aircraft, ducted propeller thrust units 107 driven by motors behind the propeller are used. The propeller itself should have variable blade pitch angle control to enable varying amounts of thrust both forward and rearwards to be developed. This will be necessary to provide precise control, particularly during launch or capture and payload pickup or set down.

Power for/from the thrust unit motors either may be drawn from electrical installations housed in the thrust unit support structure 110, as discussed above, or (as an engine with generators) may be supplied to the power distribution system. Additional small and self contained auxiliary power units 144 may also be installed in the thrust unit support structures, to boost or provide power for the aerodynamic lift system.

Four (although a minimum of 2 may be acceptable) thrust units 107 are shown in the figures, suspended below the stiffening ring, which are needed for yaw and horizontal translation control. The units are aligned tangentially with the ring. Further units could be installed (improving failsafe aspects). This however, does not alter the concept and will be for the developer to decide. These arrangements are similar to those already developed for other uses. The particular arrangements will be for the developer to undertake/decide.

The thrust units also may be provided with a vector system to rotate the duct for alignment of the thrust, as desired, although not needed with this configuration. Several airships and other aircraft have used such mechanisms for similar purposes, so this does not need to be elaborated. The particular arrangements will be for the developer to undertake/decide.

As the aircraft translates horizontally it is possible that the lift generated would be unequal, tending to cause roll and or (due to gyroscopic effects) pitch. If this is a problem then either the pitch control mechanism will need to operate in a way that compensates adequately (similar to helicopter blade controls) or the thrust units 107 used to compensate (from appropriate vectored thrust). With the strong pendulum effect of the weight below the lift, tending to keep the aircraft upright, it is thought that this will be unnecessary.

In addition to thrust and lift control other controls will be necessary, such as:
ballast dump—to reduce weight,
helium valves—to reduce aerostatic lift,
envelope rip or holing system—to destroy aerostatic lift.

These are standard airship features, the particular arrangements of which will be for the developer to undertake/decide.

Navigation lighting 146 and a transponder (not shown) will also be necessary, to comply with the Air Navigation Order. These are mandatory, the particular arrangements of which will be for the developer to undertake/decide.

The payload suspension and containment system 105, effectively is a separate packaging method (not part of the aircraft) that enables efficient transport of the payload as an under slung load beneath the working module. A single line 117, discussed previously, may be used for this purpose that connects via an automated mechanism to the top of the payload transport jacket 147. The mechanism would be the same as that described previously at the mooring site centre for Launch/Capture.

The payload transport jacket 147 is a spherical fabric pressure stabilised envelope, similar to a balloon (inflated and stabilised with air), that completely enshrouds the payload within it. Rigid carriage structure (not shown) located at the top, within the transport jacket, would support both the payload and the transport jacket plus provide the necessary interface for connection to the aircraft's lower line 117. Systems to pressure stabilise the spherical envelope in a manner similar to those used for non-rigid airship envelopes also would be provided on the carriage structure and be powered via an umbilical line from the aircraft (not shown). Large ground blowers would be used to initially and rapidly inflate the jacket with air, its own system being used just to maintain levels for pressurisation after inflation.

A variety of methods familiar to those in the heavy lift industry may be used to support and restrain the payload from the rigid carriage structure, so do not need to be elaborated here. Also, the payload is an unknown quantity that may need particular methods for its support. Whatever, these methods will need to be arranged to suit the payload and be provided in a way that complies with aircraft requirements plus the operating conditions of flight. The particular arrangements adopted will be for the developer to undertake/decide.

It is envisioned that the support arrangement and transport jacket would be prepared and be inflated beforehand, ready for the aircraft to transport the package. Crane facilities, high reach facilities and steadying methods would be necessary for these pre-arrangements. If the jacket is provided in two hemispherical halves (upper and lower) with zipped seals and lacing methods to hold the hemispheres together then the crane may be used to:
1. lift the payload into the lower hemisphere (spread on the ground);
2. lift the upper hemisphere with the rigid carriage over the payload and hold it whilst the payload support arrangements are connected and rigged (tensioned);
3. lift and hold the rigged payload as necessary whilst the hemispheres are joined, sealed and then the jacket inflated;
4. transfer support to temporary rigs and steadying facilities positioned inside, around and below the jacket, as necessary.

The payloads, as mentioned before, are an unknown quantity that will vary in size, weight and form. The transport jacket will thus standardise the package to be transported, enabling flight characteristics that are known and will not vary. If unsteady characteristics arise from the spherical form then aerodynamic modifications may be adopted, as necessary, to provide a commercially re-useable and safe jacket system. Such modifications, however, do not change the principle of the method and will be for the developer to undertake.

It is suggested that several differently sized transport jackets be developed to cover the range of circumstances that will be necessary in such transport operations. Some operations may also require transport without the jacket and these will need special consideration, which the developer should undertake.

The aircraft described above in relation to FIGS. 7 to 16 is intended for use at normal flight altitudes. In a further embodiment of the present invention, the aircraft may be designed to operate in the stratosphere. The main problem that the aircraft has to overcome for Stratospheric applications is expansion or contraction of the lifting gas through the respective ascent or decent stages. In the case of the aircraft of the present invention, the main gas containment chamber 106 would be provided with a ballonet 113(a) of 100% capacity compared with the lifting gas chamber 106, and associated valves and blowers. Instead of being attached to the lower envelope 113, the ballonet 113(a) would be provided as a dished diaphragm that is attached and extends diametrically across the ring 9 at the inner centre position of the main ring 109. The ballonet 113(a) should drape against the lower membrane 14 when empty and fill to fit against the upper membrane 12 when the ballonet 13(a) is full. In this way a wide range of altitudes into the stratosphere may be flown. The 100% ballonet 13(a) also would aid initial inflation, since this may be used to stabilise the Lifter body shape before the Lifting gas is introduced.

The principal difference between the first and second embodiments is that the first embodiment is an unpressurised system whereas the second embodiment is a pressurised system (preferably the tubular ring is pressurised in both embodiments).

It is envisaged that some of the features of the first and second embodiments are interchangeable, without departing from the scope of invention, for example the suspension system or the fan blade arrangement of the second embodiment could be used by the first embodiment, according to user requirements. Of course, if the second embodiment is adapted for stratospheric conditions it may be in the form of the first embodiment with the lower envelope “sucked up” as described above.

1. An aircraft comprising an envelope that is inflatable with a lifting gas that is lighter than air and has, at least when inflated, curved upper and lower surfaces, a payload carrying means, and an aerodynamic lifting means operable to generate lift on the envelope by causing a vertical annular flow of air that further induces a flow of air over the respective incident curved upper or lower surface.

2. An aircraft according to claim 1, wherein the aerodynamic lifting means comprises a plurality of aerofoil blades mounted for rotation around a periphery of the envelope.

3. An aircraft according to claim 2, wherein the aerofoil blades are variable pitch blades, and blade pitch control means are provided for varying the pitch of the blades collectively to effect directional control of the resulting annular air flow.

4. An aircraft according to claim 1, wherein thrust control units are attached to the envelope to provide directional thrust to the aircraft.

5. An aircraft according to claim 1, wherein the plan shape for the envelope is selected from a circular, oval, ogival or elliptical shape.

6. An aircraft according to claim 5, wherein the envelope is of circular shape when viewed in plan and the blades rotate about a vertical centre-line axis of the envelope.

7. An aircraft according to claim 5, wherein the envelope is of a lenticular shape when viewed in elevation.

8. An aircraft according to claim 8, wherein the aerodynamic lift generator comprises a plurality of aerofoil blades equispaced around the perimeter of the envelope that rotate around the envelope.

9. An aircraft according to claim 8, wherein each of the blades is a low aspect ratio wing and is mounted on a torque tube retained for pivotal movement about its longitudinal axis in a rotatable rigid ring.

10. An aircraft according to claim 9, wherein the rigid ring is able to rotate on rollers held in sleepers that constitute a track way provided on the outer face of the stiffening ring of the envelope.

11. An aircraft according to claim 9, wherein the rigid ring accommodates a plurality of pinion gears, there being a pinion gear for each blade, and each blade is provided with a rack with which one of the pinion gears engages, so that rotation of the pinion gear alters the pitch of the blade.

12. An aircraft according to claim 11, wherein the pinion gears are interconnected by a flexible torsion shaft that is supported by bearings and universal joints around the rigid ring to ensure synchronisation and collective movement of the pitch of the blades when the torsion shaft is rotated.

13. An aircraft according to claim 12, wherein the torsion shaft is driven at equispaced positions around the ring.

14. An aircraft according to claim 8, wherein each blade and an associated torque tube is mounted on a carriage that is connected to adjacent carriages around the perimeter of the envelope to form a driven part of a linear electric motor that functions to propel the blades around the periphery of the envelope.

15. An aircraft according to claim 1, wherein the aerodynamic generator comprises an electro-kinetic system in which air circulation over the respective incident curved upper or lower surfaces is created by electrostatic effects.

16. An aircraft according to claim 1, wherein the aerodynamic lift generator comprises a plurality of air discharge nozzles through which pressurised air issues and induces air flow over the respective incident upper or lower surface of the envelope.

17. An aircraft according to claim 1, wherein additional means are provided to induce air flow over the respective incident upper or lower surface of the envelope.

18. A lighter-than-air vehicle comprising; a structural ring member having attached around a perimeter thereof a first flexible gas impermeable membrane, a second flexible gas impermeable membrane, and a diaphragm that, at least temporarily, is located between the first and second membranes to define an upper chamber that is inflatable with a lifting gas bounded, at least in part, by the first membrane and the diaphragm, and a lower chamber bounded at least in part by the second membrane and the diaphragm, said diaphragm being either removable after the upper chamber is inflated with a lifting gas but prior to the first ascent of the vehicle, or having venting means for allowing the lifting gas in the upper chamber to expand and pass through the diaphragm during ascent of the vehicle, thereby to allow the lifting gas to expand into the space bounded at least in part by the second membrane; and a payload capsule suspended from the structural ring member.

19. A vehicle according to claim 18, wherein the structural ring member is a hollow inflatable structure.

20. A vehicle according to claim 19, wherein the structural ring member is a hollow rigid structure.

21. A vehicle according to claim 19, wherein the structural ring member is a flexible structure.

22. A vehicle according to claim 21, wherein the structural ring member has internal bulkheads.

23. A vehicle according to claim 18, wherein the first membrane forms a dome shape when inflated.

24. A vehicle according to claim 18, wherein the second membrane is of a distended conical shape and is attached at an upper end around a circumference of the structural ring member.

25. A vehicle according to claim 18, wherein the second membrane is provided with a lower ring member attached to a lower end of the second membrane.

26. A vehicle according claim 18, wherein a payload capsule suspension system is provided comprising tie members that extend in a radial direction from the structural ring member to an upper hub assembly, and a downwardly directed tie member that extends vertically from the upper hub assembly, and the payload capsule is connected to a lower support hub attached to the lower end of the downwardly directed tie member.

27. A vehicle according to claim 26, wherein the lower ring member is moveable vertically relative to the downwardly directed tie member.

28. A vehicle according to claim 27, wherein the payload capsule is attached to the lower ring member by way of retractable tension lines that urge the lower ring member towards the payload capsule.

29. A vehicle according to claim 26, wherein a gaiter is provided between the lower ring member and the lower support limb to allow vertical movement of the lower ring relative to the lower support limb.

30. A vehicle according to claim 18, wherein the diaphragm is connected to the structural ring member by a joint that enables the diaphragm to be removed prior to the first ascent of the vehicle.

31. A vehicle according to claim 18, wherein the diaphragm is provided with controlled venting means for allowing lifting gas from the upper chamber to expand and flow through the diaphragm into the lower chamber in a controlled manner.

32. A vehicle according to claim 18, wherein propulsion means are connected to the structural ring member.

33. A vehicle according to claim 18, wherein solar power panels are located on the upper membrane.

34. A vehicle according to claim 18, wherein a mast is provided that projects upwardly from the upper membrane of the upper chamber.

35. A method of launching a vehicle constructed in accordance with claim 1, the method comprising securing the vehicle to the ground by mooring lines inflating the upper chamber with a lifting gas that is lighter than air, evacuating the lower chamber to provide a volume for receiving expanded lifting gas from the upper chamber, and releasing the mooring lines.

36. A method according to claim 35, including the steps prior to inflating the upper chamber with the lifting gas of inflating the upper and lower chambers with pressurised air so as to raise the structural ring member and the upper chamber from the ground, and subsequently evacuating the upper chamber of air.

37. A method of launching a vehicle constructed in accordance with claim 18, the method comprising securing the vehicle to the ground by mooring lines inflating the upper chamber with a lifting gas that is lighter than air, evacuating the lower chamber to provide a volume for receiving expanded lifting gas from the upper chamber and releasing the mooring lines.
